(19) United States
(12) Patent Application Publication
(10) Pub. No.: US 2009/0241536 A1
(43) Pub. Date: Oct. 1, 2009

(54) Stirling Engine Having a Rotary Power Piston in a Chamber that Rotates with the Output Drive

(76) Inventors: Richard A. Gale, Vineyard Haven, MA (US); Nancy M. Tesch, Vineyard Haven, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/146,969

(22) Filed: Jun. 26, 2008

Related U.S. Application Data
(63) Continuation of application No. PCT/US06/62749, filed on Dec. 29, 2006.
(60) Provisional application No. 60/755,159, filed on Dec. 30, 2005.

(51) Int. Cl. F01B 29/10; F02G 1/04

(52) U.S. Cl. 60/526; 60/517

(57) ABSTRACT

A power piston mechanism for a Stirling cycle engine for operation with a Stirling engine regenerator gas system, including an outer body having a chamber rotatably carried therein on a chamber axle; a power rotor confined in the chamber, the rotor being generally elongated, and having a rotor axle for rotation parallel to the chamber axle; a double eccentric gear train from the rotor to the outer body; a regenerator gas input port in the outer body for feeding gas from the regenerator gas system into the chamber and a regenerator gas exhaust port in said outer body for feeding gas from said chamber to the regenerator gas system, whereby high temperature gas from the regenerator gas system, fed to the chamber, causes rotation of the rotor which drives the chamber in rotation in the outer body producing a shaft output from the chamber axle and spent gas flow from the chamber which is returned to the regenerator gas system. In another embodiment the heating and cooling sources are contained in the outer body.

### CROSS REFERENCE TO RELATED APPLICATIONS

The present application is a continuation of International Application No. PCT/US06/62749 filed Dec. 29, 2006 and published Jul. 12, 2007 as International Publication No. WO 2007/079421, designating the United States, and which claims benefit of the filing date of U.S. Provisional Application Ser. No. 60/755,159, filed Dec. 30, 2005, the teachings of which are incorporated herein by reference.

### FIELD OF THE INVENTION

This invention relates to Stirling cycle engines having a rotary piston mechanism adapted to operate as a Stirling engine wherein a rotating piston, or rotor, captured in a rotating chamber moves eccentrically with respect to an output drive shaft and drives the output shaft and, additionally, to sealing vane arrangements for the rotor.

### BACKGROUND OF THE INVENTION

Modern concerns with the need to reduce chemical and noise pollution of the atmosphere have revived interest in the Stirling engine. This engine was first invented in 1816 by the Rev. Robert Stirling, then a junior Presbyterian minister at Kilmarnock, Scotland. Its early development was hampered by a lack of materials with sufficient strength and corrosion resistance at high temperatures and a lack of suitable materials and techniques for gas sealing. For this reason, it was unable to compete with the steam engine or internal combustion engine, though it may be capable of higher thermal efficiency, may be much quieter and may be designed to produce far less atmospheric pollution.

### The Stirling Engine Cycle

In contrast with the internal combustion engine, in which the fuel is burned inside the main engine cylinders, the Stirling engine receives its heat supply through the cylinder walls or from a heat exchanger in communication with a heat source. The “working gas”, which usually has a fixed volume and remains permanently inside the engine, is made to undergo a continuous series of cycles of heating and cooling, which causes the cyclic expansion and contraction required for performing mechanical work.

In one popular early Stirling engine arrangement, a displacer piston slides back and forth along a gas filled cylinder which is heated at one end and cooled at the other end. The gas is therefore transferred alternately to the hot and cold spaces at the ends of the cylinder and the resultant cyclic temperature changes cause pressure changes, which are used to drive an output power piston through a connection pipe. Many ingenious mechanisms have been devised for maintaining the correct relationship between the movements of the two pistons. In most cases, the movements of the displacer pistons are arranged to occur in advance of those of the output power piston by about one quarter of the engine cycle.

In early engines, the working gas was air at about atmospheric pressure, but in most modern engines the pressure is raised (in some cases to several hundred atmospheres), and air may be replaced by helium or hydrogen, since these gases are preferred at the extremes of temperature which occur in the engine cycle. It is therefore advantageous to make the temperature of the hot end of the engine as high as the properties of the construction materials will allow, and most engines may operate in the range of about 850° F. to about 1400° F.

The Stirling engine has found limited use, however, during the last few years engines with higher efficiency and similar output power for a given weight and size to gasoline and diesel engines have been developed. The main barriers which prevent the adoption of the Stirling principle for high power engines include the well-established position of gasoline and diesel engines in the marketplace and the relatively high cost of the heat exchanger required for passing the large amounts of heat into and out of the engine.

Another promising potential application of the Stirling principle lies in its “reversibility”. If a Stirling engine is driven by externally applied mechanical power, without the application of a heat source, the engine continues to draw in heat at what would normally be its hot end, thereby cooling it, and rejects heat at what would normally be its cold end, thereby heating it. In this mode of operation it has been demonstrated as a particularly efficient refrigerator for temperatures in the range of about −70° F. to about −292° F. It could also be used as a heat pump, for example, to draw in heat from the outside environment for heating buildings.

Any form of heat source may be used, for example, the sun's radiation, a wood fire, landfill and digester gas and low grade waste fuels. The cold space could be arranged to be in the shade and, perhaps, be cooled by pumped water.

### Hybrid Power for Automobiles

The hybrid power unit for automobiles has various functions depending on the configuration. In a parallel hybrid, the unit drives the wheels through a transaxle. In a series hybrid, it drives an alternator to produce electricity. The candidates for the hybrid power unit consist of internal combustion engine technologies with fuel cells as an attractive longer term possibility. Fuel use in these engines is another variable, with reformulated gasoline, natural gas, alcohols, and other alternative fuels impacting both emissions and driving performance.

Important factors in considering hybrid power unit technologies for automobile applications include high energy efficiency, reduced emissions (in relations to current and future standards), and good transient response. The ability to use diverse fuels and specific power and power density equal to or higher than that of conventional engines are also important factors. Other factors to consider include noise and vibration reduction, reliability, durability, maintenance experience, operating costs and safety levels equal to or superior to current levels.

The Stirling cycle external combustion engine has certain characteristics that make it a potential candidate for an automobile hybrid power unit. Among these are high thermal efficiency, potential for low emissions, and low noise. The principle disadvantage is low power density due to external combustion and large heat rejection requirements. In addition, there is a clear need for much more experience with Stirling engines in automotive applications. Most working knowledge of the technology is in aerospace and cryogenic cooling applications. Previous work has shown that the transient response of the engine is poorly matched to conventional drive train vehicle demands. For a series hybrid, this constraint would be mitigated, thus the engine is potentially attractive in some automobile hybrid power unit applications. Recent technical achievements have overcome some of the past problems so that a Stirling engine may be in contention for future automobiles. As mentioned above, some of the advantages it may offer include very smooth, quiet and continuous operation producing very low emissions, and an ability to run on many types of fuel.

### Rotary Piston Internal Combustion Engines

Rotary piston internal combustion engines exemplified by the Wankel type engine have a generally triangular shaped rotor in an epitrochoidal chamber. The rotor is eccentrically driven in the chamber as it rides eccentrically about a fixed centrally located gear. Thus, the output drive shaft connected to the rotor is driven at the same rotation rate as the rotor. Three points of the rotor are equipped with sliding seals that engage the inner walls of the chamber and divide the chamber into three spaces, each bounded by one of the faces of the rotor. During a complete revolution of the rotor, each of these spaces moves around the chamber increasing and decreasing in size to perform the four functions of intake, compression, power and exhaust as a gasoline/air mixture is drawn into the space, compressed, combined to deliver power as it expands, and then finally, exhausted. These functions are performed in all the moving spaces during each rotation of the rotor in the chamber and the power function is performed consecutively in the spaces, always along the same portion of the walls of the chamber. The other functions are also performed consecutively in each of the spaces along a given portion of the walls of the chamber. Thus, the combustion and exhaust functions, which inflict the greatest wear on the walls of the chamber, occur repeatedly along the same portions of the chamber walls causing the effectiveness of the seals carried at each of the points of the rotor to degrade along these portions of the chamber walls.

It is intrinsic to the Wankel type engine and to any type rotary piston mechanism that uses a triangular shaped rotor which seals against the chamber walls at the point of the triangle, that the chamber be epitrochoidal with two symmetrical cusps. Hence, with respect to the axis of the chamber, the walls of the chamber are curvilinear and concave at all points except at the two cusps. At that point, the walls are generally convex with respect to the chamber axis. Hence, the seals must follow a concave wall which changes abruptly to convex at two points along a complete cycle of travel of the seal against the wall and the angle the seal subtends with the wall is not constant during the entire travel of the seal along the wall. In fact, that angle becomes exceedingly acute as it moves along the wall from a convex portion of the wall to a concave portion. The effectiveness of the seal where the angle is exceedingly acute is thus diminished and the seals may have a tendency to leak at such points.

Another rotary piston mechanism in which some of the disadvantages of the Wankel type mechanism are avoided is disclosed in U.S. Pat. No. 4,111,617, entitled “Rotary Piston Mechanism”, issued Sep. 6, 1978, in which the inventor herein is a co-inventor and which is included herein by reference in its entirely. This patent discloses an oblong rotary piston or rotor in a generally triangular shaped chamber defined by three equal curved walls that are convex with respect to the chamber axis. Each side of the rotor conforms generally to the chamber wall and the rotor is rotatably mounted so that it rotates about its geometric center and the geometric center moves around the chamber axis over a three cusp epicycloidal path. For each cycle of rotation of the geometric center of the rotor around the chamber axis along the epicycloidal path, the rotor rotates one-half cycle on its geometric center and so the rotor closes exclusively with the three walls of the chamber six times for each full revolution of the rotor. In addition, seals at the ends of the rotor which slide along the walls of the chamber can at all times contact the walls perpendicular thereto. More particularly, a gear train is provided which is carried by at least one of the rotating chamber end plates that carries the rotor for rotating the rotor on the rotor axis (geometric center). Thus, both the position and the attitude of the rotor in the chamber are positively controlled by gears and are independent of forces between the rotor and the side walls of the chamber.

The '617 patent describes embodiments of a rotary piston mechanism wherein the rotor is of fixed dimension from end to end. In other words, the dimension of the rotor from vane tip to vane tip is fixed. In that case, there are three equal convex chamber side walls that define an equilateral triangle and the span of the chamber along a bisector of any of the angles of the equilateral triangle must be precisely equal to the length of the rotor from vane tip to vane tip. One of the embodiments described in that patent (see FIG. 12) may also be used in a rotary piston mechanism in which the length of the rotor from vane to tip to vane tip changes during a cycle of rotation and so the chamber shape need not define an equilateral triangle. For example, the chamber may be circular and the sealing vanes carried by the vane tip to divide the chamber at all times into two sections each sealed from the other.

Some of the problems that arise for a rotary piston device in a circular chamber include: the need to extend the vanes unequal distances as the rotor rotates; sealing each end of a major diameter of the rotor against the chamber wall; providing a drive mechanism within the rotor to drive seals outward against the chamber wall; and providing a mechanism that holds the seals forcefully against the chamber wall.

Embodiments of the present invention incorporate mechanical designs that overcome these problems by; locating the pivot points of the rotor with respect to the chamber on a circle of larger diameter than the chamber diameter (outside the chamber) so that the vanes extend equal distances; providing that sealing vanes project from slots at each end of a major diameter of the rotor; locating a cam within the rotor to drive the vanes outward against the chamber wall; and providing springs to hold the vanes forcefully against the chamber wall.

Heretofore, rotary piston combustion engines like the Wankel type and the engines disclosed in said U.S. Pat. No. 4,111,617 have been limited to internal gas combustion. Thus, adaptation to operation as a Stirling cycle engine promises to improve efficiency by significantly increasing the number of displacements of the rotor per revolution of the driveshaft. With a triangular chamber, the present invention may provide, for instance, 6 displacements per revolution and with a circular chamber, 12.

### SUMMARY OF THE INVENTION

Accordingly, it is an object of the present invention to provide a Stirling cycle engine wherein at least some of the above-mentioned problems or disadvantages with the engine are avoided or overcome.

The present invention comprises a rotary piston mechanism having a double eccentric that is caused to rotate by way of a gear train. The mechanism may have a static outer chamber and rotating inner chamber, which contains the piston or rotor, with appropriate porting for both expanding and expended gases. In particular, the present invention provides a Stirling engine with much greater displacement than earlier designs. This then provides the potential to produce greater power (KW/HP) for an equal size (physical outside dimensions) engine.

In a first exemplary embodiment, a power piston mechanism for a Stirling cycle engine for operation with a Stirling engine regenerator gas system is provided, including an outer body having a cylindrical, that is, circular in cross-section, chamber rotatably carried therein on a chamber axle; a power rotor confined in the chamber, the rotor being generally elongated and having a rotor axle for rotation parallel to the chamber axle; a double eccentric gear train from the rotor to the outer body; a regenerator gas input port in the outer body for feeding gas from a regenerator gas system into the chamber and a regenerator gas exhaust port in the outer body for feeding gas from the chamber to the regenerator gas system. High temperature gas from the regenerator gas system, fed to said chamber, causes rotation of the rotor which drives the chamber in rotation in the outer body producing a shaft output from the chamber axle and spent gas flow from the chamber which is returned to the regenerator gas system.

In a second exemplary embodiment, the present invention comprises a power piston mechanism for a Stirling cycle engine for operation with a Stirling engine regenerator gas system, including an outer body having a 3-lobed, that is substantially triangular in cross-section, chamber rotatably carried therein on a chamber axle; a power rotor confined in the chamber, the rotor being generally elongated and having a rotor axle for rotation parallel to the chamber axle; a double eccentric gear train from the rotor to the outer body; a regenerator gas input port in the outer body for feeding gas from the regenerator gas system into the chamber and a regenerator gas exhaust port in the outer body for feeding gas from the chamber to the regenerator gas system.

In a third exemplary embodiment, the present invention comprises a Stirling cycle engine having a rotary power piston for a circular or triangular chamber that rotates with the output drive, the engine containing the heating and cooling systems and not requiring a separate regenerator.

It is an object of the present invention to provide a Stirling cycle engine having a rotary power piston in a chamber that is driven in a rotating motion, with a drive train from the piston to an output drive shaft that is carried inside the piston and through the chamber wall at a part of the chamber wall that is covered throughout the engine cycle of operation.

It is a further object that the drive train exposure to the engine driving gas be minimized.

It is a further object of the invention to provide a Stirling cycle engine that does not require the conventional crankshaft arrangement of piston and piston rod connected to the crankshaft.

It is a further object to provide such an engine wherein the rotor vanes project an equal amount throughout a power stroke.

It is a further object to provide such an engine wherein the rotor vanes are driven by a common drive carried by the rotor.

Accordingly, the entire rotating chamber including the wall and front and back plates that carry the rotating piston (rotor) may be fixedly attached to the output drive shaft that is journalled to the grounded housing. The chamber rotates with the output and the rotor engages the housing at the internal gear of the major eccentric that is fixed to the housing.

One feature of the present invention is that the pivot point of rotation of the rotor may be located outside of the chamber wall, in other words, the pivot points are equally spaced on a circle of greater diameter than the diameter of the circular rotating chamber. The combined result of moving the pivot point outside of the cylinder wall and having equal vane travel provides for a smoother rotating/sweeping action of the rotor within the chamber as opposed to an interrupted movement caused by a pivotal action at the chamber wall.

One other embodiment of the present invention provides for a chamber which is circular in cross-section with rotor sealing vanes, the vanes being of equal length and extending equal distances from slots at each end of the rotor and having their maximum extension halfway through the rotor stroke. With vanes which extend equally at all times, it is possible to simplify the drive in the rotor that extends the vanes and permit the use of a single cam to drive both vanes. These features with their attendant advantages are achieved by increasing the diameter of the pinion gear of the minor eccentric gear train to greater than the diameter of the pinion gear of the major eccentric gear train causing the pivot point to move outward of the cylinder wall and resulting in equal vane extension from each and of the rotor. This design also may cause the major diameter of the rotor to move lower into the chamber such that the minor diameter of the rotor decreases, resulting in a smaller (shorter and thinner) rotor and providing a greater available working volume. Moving the chamber walls inward from the pivot points may have the same effect, that is, shorter vane travel, a smaller rotor and a greater available working volume as well as a smaller cylinder diameter. In addition, by changing the gearing, multiple displacements per revolution of the rotor may be provided, up to, for instance, 12/1.

In another exemplary embodiment, with a triangular chamber, spring-loaded static vanes may be provided which extend from the rotor to seal against the chamber wall and simplify the construction of the rotor.

Other objects, features and advantages of the present invention and various embodiments thereof will be apparent from the following description of these features and embodiments taken in conjunction with the drawings.

### DESCRIPTION OF THE DRAWINGS

FIG. 1 is a cross-sectional view taken through the output drive shaft, the housing, the chamber and the rotor that illustrates a basic embodiment of the present invention of a rotary power piston Stirling cycle engine.

FIG. 2 is a cross-sectional view taken at 2-2 of FIG. 1 of the rotary power piston Stirling cycle engine of the present invention.

FIG. 3 is another cross-sectional view taken at 3-3 of FIG. 1 of the rotary power piston Stirling cycle engine of the present invention.

FIG. 4 is an enlarged cross-sectional view of the sliding vanes in the rotor of FIG. 2 that ride against the cylinder wall, taken along line 4-4 of FIG. 1.

FIG. 5 is an enlarged cross sectional view taken at 3-3 of FIG. 1 illustrating an alternative spring-loaded static vane seal in a rotating power piston in a rotating chamber having a 3-lobed inner wall, according to the present invention.

FIG. 6 is a cross-sectional view taken through the output drive shaft, the housing, the chamber and the rotor that illustrates a third (self-contained) embodiment of the present invention, a rotary power piston Stirling cycle engine.

### DETAILED DESCRIPTION OF THE INVENTION

### Rotating Power Piston Stirling Cycle Engine

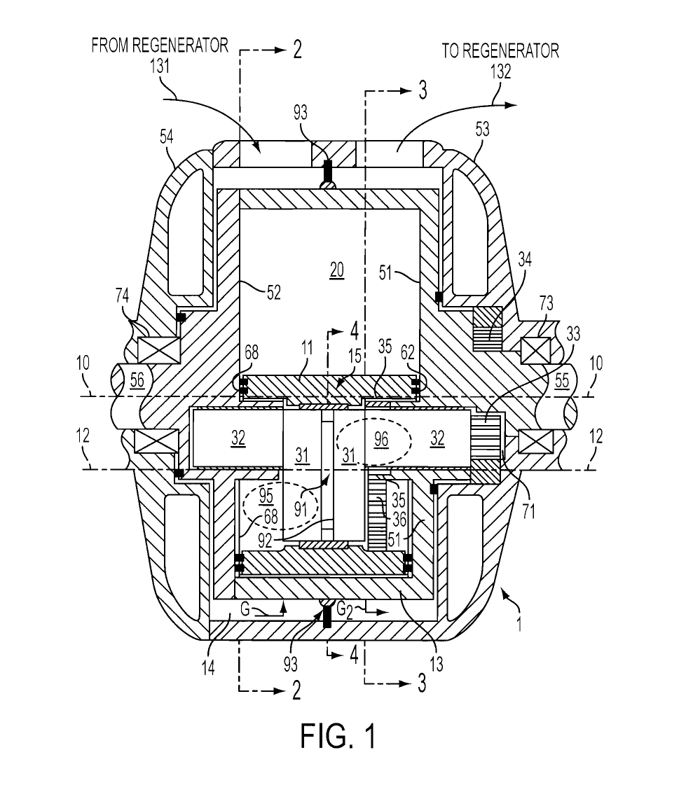

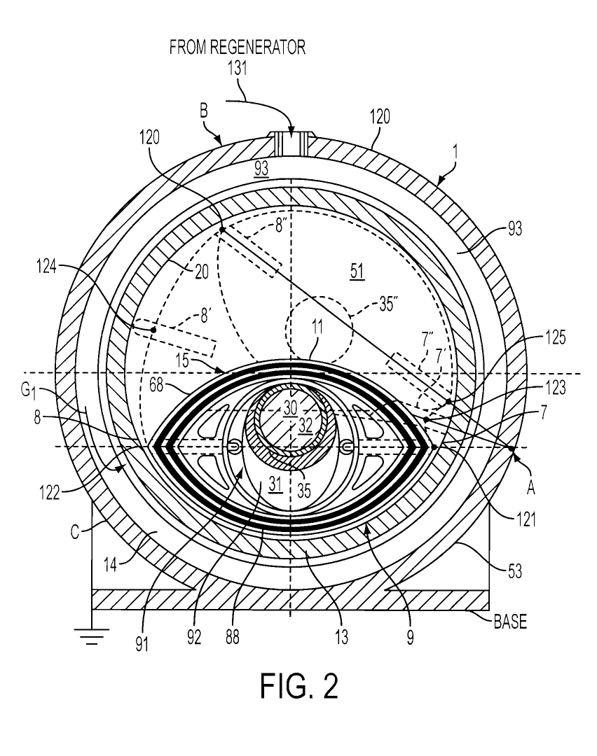

FIGS. 1 and 2 are cross-sectional views of a rotary piston mechanism 1, such as described in above-referenced U.S. Pat. No. 4,111,617, that has been adapted to perform as a Stirling cycle engine. As shown in FIG. 1, the entire chamber 13 including chamber inner cylindrical wall 20 and front and back plates 51 and 52 that carry the rotating piston (rotor) 15 may be fixedly attached to the output drive shaft 55/56 that may be journalled (73) to the grounded housing 53/54. The chamber 13 may rotate with the output and the rotor 15 may engage the housing 53 at the internal gear 34 of the major eccentric that may be fixed to the housing. An input gas passage 131 may be provided in the housing 54 to deliver expanding gas through the annular space 14 to the input port 95 in the cylindrical wall 20 of the chamber 13 from a Stirling cycle regenerator system (or heat exchanger). Similarly, an exhaust gas passage 132 may be provided in the housing 53 to deliver expended gas from the exhaust port 96 in the chamber wall 20 to the Stirling cycle regenerator system (not shown). The ports 95, 96 (shown as circled numerals to indicate that they are not in the plane of the section) may be offset around the periphery of the chamber 13, preferably at 120° from one another. In other words, port 96 is shown as a dotted line to illustrate its position on the inner wall that has been cut away by the section. Port 95 is shown partially as a solid line and partially as a dotted line since in the sectional view a portion of the port would be visible on the inner wall 20 of the chamber. A peripheral seal 93 may separate the expanding, G₁, and expended, G_{2, gases} in the annular chamber 14. The seal 93 may be spring-loaded, or labyrinth, etc. and function to separate the heating and cooling sections of the engine 1.

A regenerator gas system such as would be known to those skilled in the art and including one or more heat exchangers and/or regenerators may be used to heat and cool the working gas. This system is not described in more detail here as it is not part of the present invention.

### Rotor Position and Attitude Control Mechanisms

FIGS. 1 and 2 illustrate the mechanical action of one embodiment of the present invention for carrying the rotor 15 in a chamber 13 and controlling the position and attitude of the rotor 15 over its cycle of rotation in the chamber 13 to perform as a Stirling cycle engine. FIG. 1 illustrates an embodiment wherein the inner chamber wall 20 and end plates 51, 52 may be a rigid structure journalled to the housing 53, 54 and carrying the rotor 15 and a double eccentric axle drive 31/32 at an end thereof which may engage an internal gear fixed to the housing. The chamber may be fed power gas from a Stirling cycle engine gas regenerator system, so that the rotor may drive the output.

FIG. 2 is a cross-sectional view of FIG. 1 taken along 2-2 and illustrates the principal parts of the rotor or piston 15, the circular chamber 13 and successive positions of the piston and the piston vanes 7, 8 to allow equal vane extensions at all positions of the rotor and three or more power strokes of the rotor per revolution. This may be achieved by positioning the successive pivot points of the rotor outside of the chamber, for instance at point A.

As shown in FIG. 1, the rotor 15 may be journalled centrally to the eccentric axle 31 so that the axis of the axle 31 and the central axis 12 of the rotor 15 (at the geometric center of the rotor 15) coincide. Axle 31 may be fixed to axle 32 which may be carried by the rotating chamber end plate 51 which may be journalled to the mechanism housing 53, 54 that may attach to the outer chamber cylinder wall 20 so that the entire chamber end plates 51 and 52 may rotate on the chamber axis 10. Thus, the entire chamber 13 may rotate to deliver an output to shaft 55/56 when the mechanism is used as a Stirling cycle engine.

The two axles 31 and 32 of the rotor may be fixedly attached and are referred to herein as the double eccentric axle because the axle 32 is mounted to the plate 51 eccentrically with respect to the axis of rotation 10 of the plate 51 and axle 31 is eccentric with respect to axle 32. Thus, as the plate rotates about axis 10, both axles 31 and 32 may orbit around axis 10. In other words, the double eccentric axle 31/32 may be carried by the chamber in orbit around the chamber axis 10.

As mentioned, axle 32 may be journalled to the chamber 13 at plate 51. The axle may extend through the plate and through the pinion gear 33. The pinion gear may mesh with an internal gear 34 concentric with the axis 10 and fixed to the housing 53. The ratio of internal gear 34 to pinion gear 33 is preferably 2:1. Thus, from the initial position of the double eccentric axle 31/32 and rotor 15 represented by the solid lines in FIG. 2, the end plate 51 may rotate counterclockwise (ccw) causing the pinion gear 33 to rotate to successive positions around internal gear 34, which, in turn, positions the rotor axle 31 at the corresponding successive positions. Note that the side 9 of the rotor 15 in FIG. 2 is displayed as a solid line which becomes 9″ in a successive position, displayed as a dotted line. The gear combination of internal gear 34 and pinion gear 33 is referred to as the major eccentric and the combination of internal gear 36 and pinion gear 35 is referred to as the minor eccentric.

In operation, the rotor 15 may rotate counterclockwise relative to the rotor axle 31 so that the rotor will, in effect, rotate successively about the pivot points that are outside the chamber and fall on a circle 120 of greater diameter than the chamber 13 diameter. The first pivot point on circle 120 is denoted A, the second is denoted B, and the third denoted C. The successive points are spaced apart equally, but do not necessarily fall at the same position with respect to the housing for each revolution of the rotor. Reference numerals 122, 124 and 126 represent the position of one end of the rotor 15 as it pivots around point A, as vane seal 8 becomes 8′ and 8″. Correspondingly, the opposite end of the rotor 15 moves from 121 to 123 to 125 and vane seal 7 becomes 7′ and 7″, respectively.

The minor eccentric gear train may include a pinion gear 35, concentric with axle 32 and rotatably received in the plate 51 meshing with an internal gear 36 concentric with axle 31 and to the rotor 15. The ratio of gears 36 to 35 is preferably 2:1. Clearly, as the chamber 13 rotates counterclockwise, gear 35 moves to the successive position 35″ shown in FIG. 2 and since it is fixed to chamber plate 51, it orbits around chamber axis 10 and rotates ccw about the axis of axle 32. Meanwhile, the rotor axle 31 may move along a hypocycloidal path and rotate clockwise on axis 12.

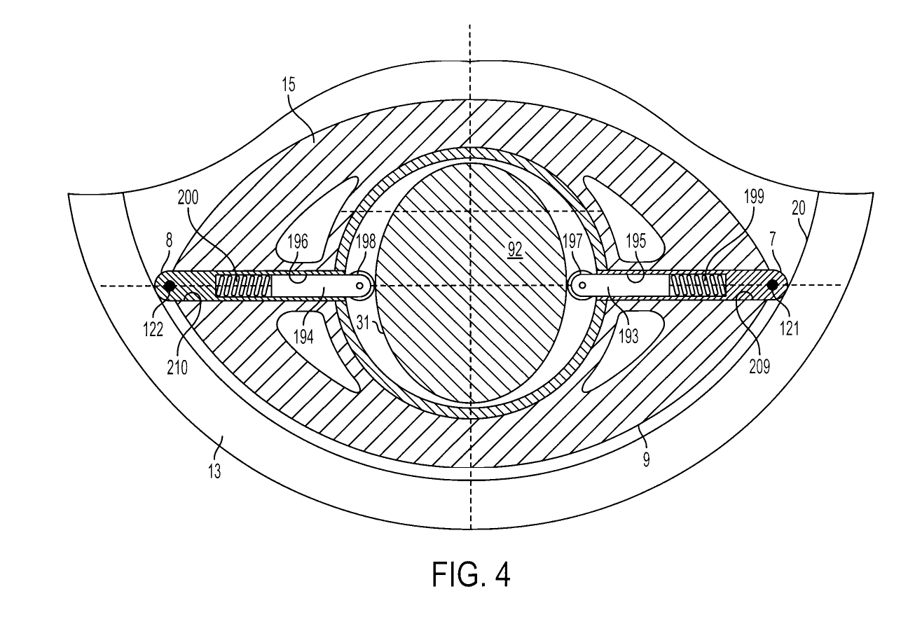

Thus, the rotor position is precisely determined by the major eccentric and the rotor attitude is precisely determined by the minor eccentric gear train. Both rotor position and attitude are independent of any forces exerted at the rotor vane tips 7 and 8 where they contact the chamber side wall 20 (FIG. 2). The vanes are driven by cam 31 (See FIG. 4) to extend equally at all times to seal against the cylindrical side wall 20 of the chamber dividing the chamber into the two parts bounded by the faces 9 and 11 of the rotor. In FIG. 2, face 9 of rotor 15 bounds the compression volume and face 11 bounds the expansion volume.

### Two Cycle Operation of Exhaust/Intake Ports

Referring again to FIG. 1, intake is through housing port 131 and port 95 in chamber wall 20 and exhaust is through port 96 in chamber wall 20 and the exhaust port 132 in housing 54. A peripheral seal 93 separates the annular space 14 outside the cylindrical wall 20 into intake and exhaust portions. Note that the intake port 95 and the exhaust port 96 in chamber wall 20 are offset, out of phase, with each other so that the exhaust port registers during the cycle just before the intake ports registers. It is preferred that exhaust be complete before intake starts although some overlaps may be tolerated. As the intake portion approaches full expansion, exhaust occurs, then the exhaust port closes and then intake occurs before compression begins. Thus, the arrangement of ports for both intake and exhaust may be the same, but staggered, so that exhaust and intake occur in the desired sequence as well as at the desired position of the rotor. Intake or exhaust openings into the chamber may also be provided axially. For example, either intake or exhaust or both may be through central axial openings in the end plates 51, 52 concentric with the chamber axis 10 and the main shaft 55/56. Where such a central opening is provided in a rotating end plate, the shaft on the outside of the plate may be hollow and so provide a connecting passage to the plate opening. A control valve (not shown) in the hollow shaft or in a conduit to the hollow shaft may control the timing of the fluid flow therethrough. Where intake is provided by this technique and exhaust is through the rotating exhaust plate holes as they align with exhaust ports in the exhaust housing, exhaust occurs first and then intake. So the intake would be delayed with respect to the exhaust to insure that they do not both occur simultaneously. This may be implemented by adding a control valve before the intake opening in the drive shaft, which delays input until the holes in the rotating exhaust plate move just out of registration with the exhaust ports.

Seals 67, 68 may bridge the space between the sides of the rotor 15 and the end plates 51, 52 of the chamber 13. These seals may be spring-loaded strip seals as are known to those skilled in the art.

### Cam Driven Sealing Vanes

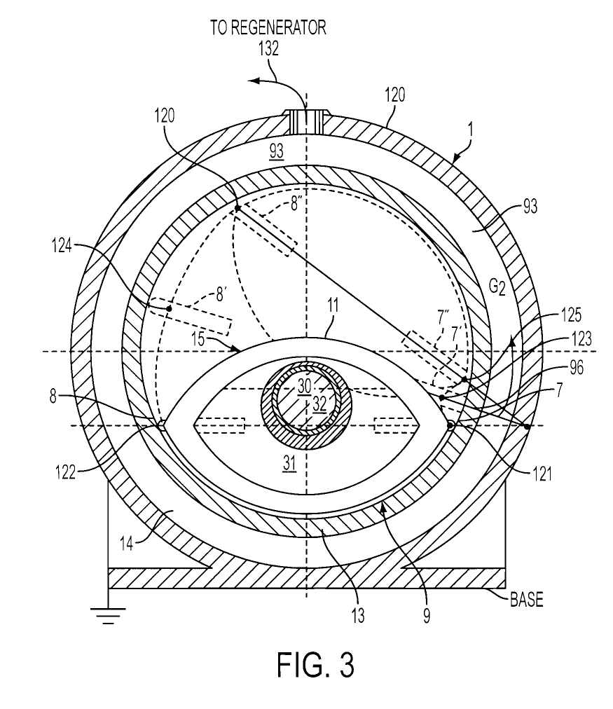

In one embodiment of the present invention, the mechanisms for controlling rotor position and attitude may be independent of rotor contact with the side walls of the chamber. The rotor 15 may be equipped with variable vanes 7, 8 that seal against the cylindrical side wall 20 of the chamber. The vanes may be driven to slide in and out at the end of the rotor 15 so that the vane tip to vane tip dimension of the rotor may change as the rotor rotates. Where the basic rotor action in the chamber is as described herein with respect to FIGS. 1 and 2, variation of the vane tip to vane tip dimension of the rotor as it rotates is required. FIG. 3 is a cross-sectional view of FIG. 1 taken along line 3-3 that illustrates the principal parts of the rotor 15, the circular chamber 13 and successive positions of the piston 15 and the piston vanes 7, 8 for equal vane extension at all positions of the rotor and three or more power strokes of the rotor per revolution. This is achieved by positioning the successive pivot points of the rotor outside of the chamber (circle 120). This cross-sectional view is taken through the gas exhaust port 132 in the housing 53 and through the exhaust port 96 in the chamber inner wall 20. As shown in FIGS. 1 and 2, a cam slot 91 is provided in the eccentric rotor axle 31 providing a generally oval shaped cam surface 92 that is preferably an integral part of the total double eccentric axle 31/32.

As shown in FIG. 4, which is an enlarged cross-sectional view taken through the center of the rotor 15 along lines 4-4 of FIG. 1, vane plungers 193 and 194 may slide in plunger bores 195 and 196 to move vanes 7 and 8 as urged by cam rollers 197 and 198, respectively, at their inside ends acted upon by the cam. These plungers contact springs 199 and 200 in the bores and the springs contact the sliding vanes 7 and 8 at the ends of the rotor 15. The sliding vanes extend the full width of the rotor and slide in accommodating slots 209 and 210, respectively. Each of the plunger springs may be loaded at all times between the plunger and sliding vane so the vane may be forced against the chamber side walls by a steady force over the full extension of the vanes 7, 8.

In operation, the rotor 15 may be carried by the end plates 51 and 52 on the double eccentric axle 31/32, and the two gear trains, the position gear train including gears 33 and 34 and the attitude gear train including gears 35 and 36. These precisely determine the position and attitude of the rotor in the chamber independent of any contact between the rotor vanes and the chamber side wall 20. As the rotor 15 rotates on rotor axle 31, cam 92 rotates with respect to the vane plunger 193 and 194 positioning the vanes 7, 8 under spring force precisely as required to seal against the circular chamber side wall 20. Thus, the rotor action is the same as already described above with reference to FIGS. 1, 2 and 3, and the end plate and housing is substantially the same. Furthermore, intake and exhaust may be accomplished using any of the techniques already described herein. The use of variable or sliding vanes permits use of a simpler circular chamber construction.

The vane seals of the present invention may include a flattened end which may articulate as the rotor moves from position to position to seal against the inner wall of the chamber.

### Spring-Loaded Static Sealing Vanes

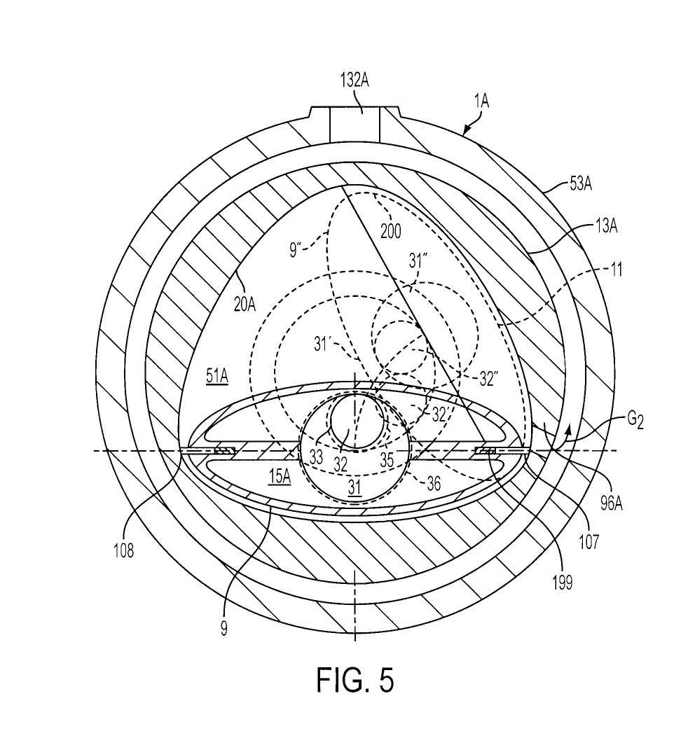

In another embodiment, an oblong rotary piston or rotor may be provided in a generally triangular shaped (3-lobed) chamber defined by three equal curved inner side walls that are convex with respect to the chamber axis. Each side of the rotor may conform generally to the chamber end walls and the rotor may be rotatably mounted so that it may rotate about its geometric center and the geometric center may move around the chamber axis over a three cusp epicycloidal path. (See FIG. 5). For each cycle of rotation of the geometric center of the rotor 15A around the chamber axis along the epicycloidal path, the rotor may rotate one-half cycle on its geometric center and so the rotor may close exclusively with the three inner walls 20A of the chamber 13A six times for each full revolution of the rotor. In addition, seals 107, 108 at the ends of the rotor 15A which slide along the walls of the chamber 20A may at all times contact the walls perpendicular thereto. More particularly, a gear train 31/32/33/34/35/36 is provided which may be carried by at least one of the rotating chamber end plates, for instance 51A, that carries the rotor for rotating the rotor on the rotor axis (geometric center). Thus, both the position and the attitude of the rotor in the chamber may be positively controlled by gears and are independent of forces between the rotor and the side walls of the chamber.

FIG. 5 illustrates a further embodiment wherein the cam actuated sliding vanes 7, 8 of FIG. 4 have been replaced by static vanes 107, 108 in a chamber having a triangular inner wall. The static vanes provide improved sealing at higher operating temperatures, may reduce the possibility of leakage and do not require any lubrication, as do the sliding vanes. The use of static vanes may provide a less expensive rotor construction as fewer components are required and maintenance is reduced as there are no moving parts.

The fixed vanes 107, 108 preferably comprise a material which has good high temperature resistance which has been inserted into an opening having a corresponding shape in the ends of the rotor 15A. The vanes may be securely fit into the openings and may protrude a sufficient amount to maintain contact with the triangular inner wall 20A of the chamber as the rotor rotates. Springs 299 and 300 may provide pressure on the vanes 107, 108 to insure contact with the triangular inner wall 20A. In this embodiment, the chamber 13A has a triangular, or 3-lobed, rather than circular inner cross-section so that the vanes do not need to vary in the amount that they project into the chamber from the ends of the rotor 15A. The use of a chamber having a triangular rather than circular cross-section as shown in FIG. 1, may provide slightly less available working space for the gas (displacement) but a simpler and potentially more durable sealing vane arrangement which may not require lubrication.

The details of operation of an engine 1A with a triangular or 3-lobed inner wall 20A in chamber 13A as a Stirling cycle engine, as shown in FIG. 5, are quite similar to those described above, for the circular chamber 13. While a 3-lobed construction has been illustrated herein, a different number of lobes may be used as long as the rotor can be designed to match the lobe shape.

With the present invention, a cylindrical chamber about 5 inches in diameter with a rotor about 2.5 inches high by 2.5 inches thick provides sufficient displacement to develop about 65 horsepower or about 48 kilowatts. Gearing may be changed to provide multiple displacement strokes per revolution of the rotor. A similar size engine with a triangular chamber may provide about 54 horsepower or 40 kilowatts.

### Self-Contained Rotating Power Piston Stirling Cycle Engine

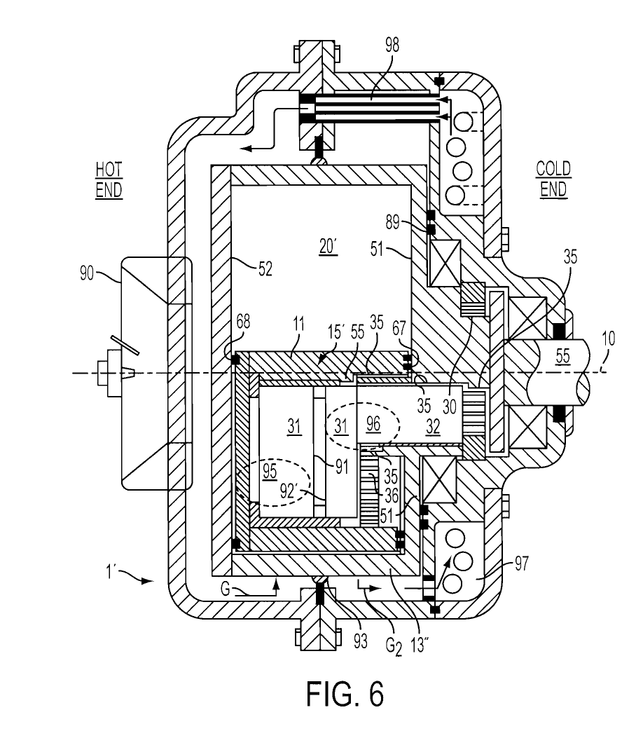

In a third embodiment, the engine of the present invention has been adapted to be self-contained, that is, it does not require a separate heating and cooling source, such as a regenerator. As shown in FIG. 6, a self-contained engine 1′ including heating and cooling systems may be provided. While shown here with a cylindrical inner wall (circular in cross-section) 20′ for the chamber 13′, the chamber may be of a 3-lobed or triangular inner shape (as shown in FIG. 5). Rather than having a through output shaft 55, the engine includes a heating source or head 90 at one (hot) end. On the other (cold) side, the engine 1′ includes a cooler 97 comprising a plurality of tubes which conform to the general shape of the engine and which cooperate with a heat exchanger or regenerator 98 to extract heat from the expended gas G₂. Heated gas G₁ then flows from the heater 90, into intake port 95, out of exhaust port 96 (as G₂) and across tubes 97.

While the present invention is shown as a singular rotating chamber with rotor therein, one may chose to add multiple chambers side by side of the shapes shown in FIGS. 1 and 5, and have pairs of chambers heating and cooling the gas. Likewise, FIG. 6 may be configured with another chamber and hot end arranged on the opposite side of the cold side to share the common cold side and provide greater output.

The embodiments of the present invention illustrate a novel adaptation of a rotary piston mechanism to a Stirling cycle engine. The embodiments also allow the control of the position and attitude of the rotary piston for a circular cross-section chamber, as described. It will be apparent to those skilled in the art that additional mechanisms may be required to provide a complete useful two cycle Stirling cycle engine operation. The operation of these and other additional mechanisms will be apparent to those skilled in the art as are various changes, modifications and other uses of the present invention that can be made without departing from the spirit and scope of the invention as set forth in the appended claims.

What is claimed is:

1. A power piston mechanism for a Stirling cycle engine for operation with a Stirling engine regenerator gas system, comprising:
i) an outer body having a chamber rotatably carried therein on a chamber axle;
(ii) a power rotor confined in said chamber, said chamber having end walls and a curved inner side wall;
(iii) said rotor being elongated and having a rotor axle for rotation substantially parallel to said chamber axle;
(iv) a double eccentric gear train from said rotor to said outer body;
(v) a regenerator gas input port in said outer body for feeding gas from said regenerator gas system into said chamber; and
(vi) a regenerator gas exhaust port in said outer body for feeding gas from said chamber to said regenerator gas system;
(vii) whereby expanding gas from said regenerator gas system, fed to said chamber causes rotation of said rotor which drives said chamber in rotation in said outer body producing a shaft output from said chamber axle and spent gas flow from said chamber.

2. A power piston mechanism as in claim 1 wherein said chamber and said outer body define an annular space therebetween, said regenerator gas ports fluidly connected to said annular space.

3. A power piston mechanism as in claim 1 wherein said regenerator gas ports are sealed from one another.

4. A power piston mechanism as in claim 1 wherein said rotating chamber has a cylindrical inner and outer wall.

5. A power piston mechanism as in claim 1 wherein said rotating chamber has a multi-lobed inner wall and a cylindrical outer wall.

6. A power piston mechanism as in claim 5 wherein said inner wall is 3-lobed, or substantially triangular in cross-section.

7. A power piston mechanism as in claim 4 wherein said rotor rotates continuously in one direction, closing successively with said inner wall a multitude of times with each revolution of the rotor and from one successive closing to the next, the rotor pivoting about a pivot point that lies outside said cylindrical chamber wall.

8. A power piston mechanism as in claim 7 wherein said rotor pivot points all lie on a circle that is concentric with the chamber circular cross-section and of greater diameter.

9. A power piston mechanism as in claim 4 wherein said rotor is substantially symmetrical with respect to a plane through the length thereof and parallel to the rotor axis having two elongated sides and two ends and the elongated sides of the rotor coincide with a end walls of the chamber when the rotor closes with the side walls of the chamber.

10. A power piston mechanism as in claim 9 wherein said rotor carries sealing vanes at said ends thereof, said sealing vanes in contact with said cylindrical chamber wall at all times, dividing the chamber volume into a compression space and an exhaust space.

11. A power piston mechanism as in claim 10 wherein said sealing vanes are carried slidably in said rotor and extend equal distances from the ends thereof, said distance changing as said rotor rotates.

12. A power piston mechanism as in claim 6 wherein said rotor is substantially symmetrical with respect to a plane through the length thereof and parallel to the rotor axis having two elongated sides and two ends and the elongated sides of the rotor coincide with a end walls of the chamber when the rotor closes with the triangular side walls of the chamber.

13. A power piston mechanism as in claim 12 wherein said rotor carries sealing vanes at said ends thereof, said sealing vanes in contact with said cylindrical chamber wall at all times, dividing the chamber volume into a compression space and an exhaust space.

14. A power piston mechanism as in claim 13 wherein said sealing vanes comprise static vanes carried in the ends of said rotor.

15. A power piston mechanism as in claim 14 wherein said static vanes comprise spring-loaded vanes.

16. A power piston mechanism as in claim 1 wherein the heating and cooling sources for the engine are contained within said outer body.
